(19) United States
(12) Patent Application Publication
(10) Pub. No.: US 2012/0006125 A1
(43) Pub. Date: Jan. 12, 2012

(54) MECHANICAL STRENGTH TESTER

(75) Inventor: YOU-XI WEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/837,489

(22) Filed: Jul. 15, 2010

(30) Foreign Application Priority Data
Jul. 7, 2010 (CN) 201010219874.8

(51) Int. Cl. G01N 3/02

(52) U.S. Cl. 73/788

(57) ABSTRACT

A mechanical strength tester includes a steel ball and a hollow cylinder including a supporting configuration. The diameter of the steel ball is less than the diameter of the cylinder. The supporting configuration is operable to support the steel ball on the top of the cylinder and release the steel ball to fall down in the cylinder under force of gravity.

### BACKGROUND

1. Technical Field

The present disclosure relates to a mechanical strength tester.

2. Description of Related Art

Mechanical strength of many electronic products needs to be tested before shipment. A common method to test and/or measure a product's mechanical strength is to drop a steel ball from predetermined height/s onto the product, and calculate the strength according to the data collected.

However, the above method typically requires two persons to perform, which is labor-expensive, and sometimes the ball may not accurately land on a desired portion of the product under test.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an embodiment of a mechanical strength tester.

FIG. 2 is a partial, exploded, isometric view of the mechanical strength tester of FIG. 1.

FIG. 3 is a schematic view of the mechanical strength tester of FIG. 1, in a testing state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

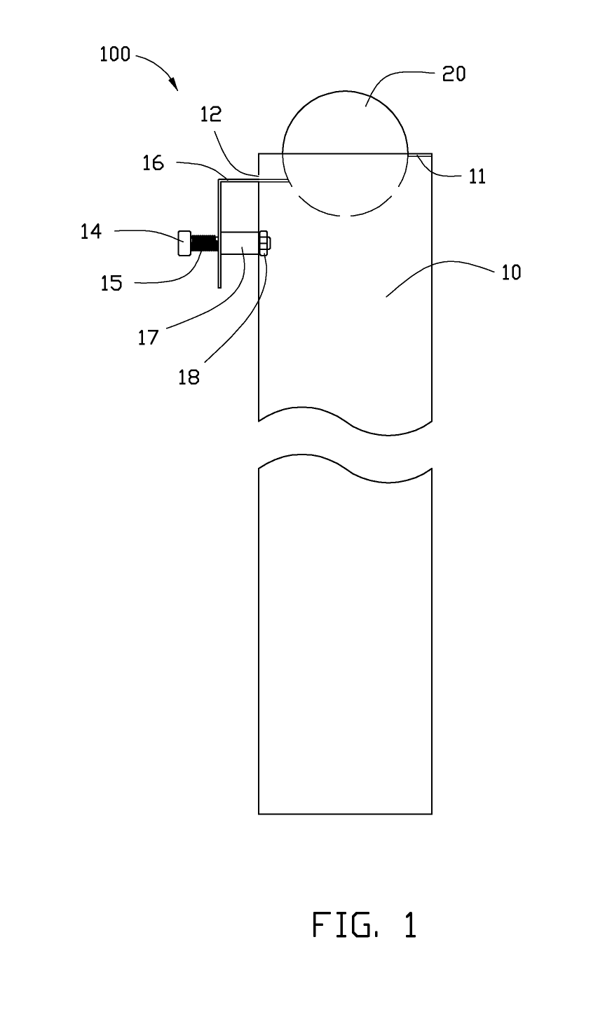

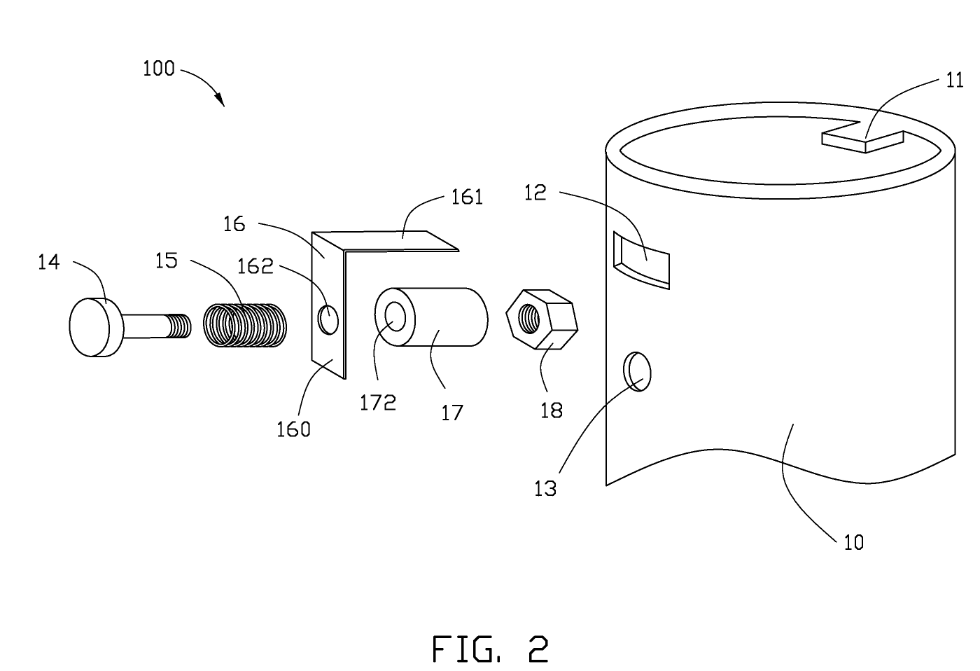

Referring to FIGS. 1 and 2, an embodiment of a mechanical strength tester 100 includes a hollow cylinder 10, a steel ball 20, a screw bolt 14, a spring 15, an L-shaped supporting board 16, a sleeve 17, and a nut 18. The diameter of the steel ball 20 is less than the diameter of the cylinder 10.

A supporting portion 11 extends in from an inner wall at the top of the cylinder 10. A rectangular through hole 12 and a round through hole 13 are defined in the cylinder 10, nearby the top of the cylinder 10. The through hole 12 is nearer the top of the cylinder 10 than the through hole 13. The supporting board 16 includes a vertical first portion 160, and a second portion 161 perpendicularly extending from a top of the first portion 160. The first portion 160 defines a through hole 162 corresponding to the through hole 13. The sleeve 17 axially defines a through hole 172 corresponding to the through hole 13.

In assembly, the screw bolt 14 is inserted through the spring 15, the through hole 162 of the supporting board 16, the through hole 172 of the sleeve 17, the through hole 13 of the cylinder 10, and then screwed in the nut 18. A distal end of the second portion 161 of the supporting board 16 is inserted into the cylinder 10 through the through hole 12 of the cylinder 10, opposite to the supporting portion 11. The supporting board 16 with the supporting portion 11 can support the steel ball 20 when the steel ball 20 is put on the top of the cylinder 10. When the distal end of the first portion 160 of the supporting board 16 is pushed towards the cylinder 10, the distal end of the second portion 161 of the supporting board 16 is moved out of the cylinder 10 through the through hole 12, thereby allowing the steel ball 20 to fall down in the cylinder 10. In other embodiments, other supporting configurations may be designed on the cylinder 10, to support and release the steel ball 20.

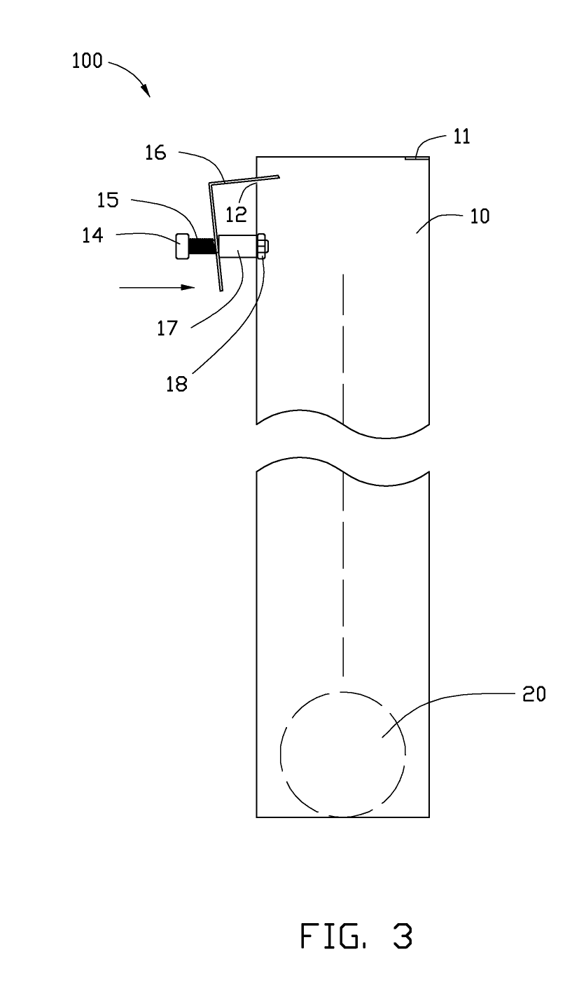

Referring to FIG. 3, in use, the cylinder 10 is vertically placed in contact with a test point of a product to be tested. The steel ball 20 is put on the top of the cylinder 10, supported by the supporting portion 11 and the second portion 161 of the supporting board 16. The first portion 160 of the supporting board 16 is pushed towards the cylinder 10 (see the arrow of FIG. 3), the second portion 161 of the supporting board 16 moves out of the cylinder 10, thereby the steel ball 20 is released and falls under force of gravity to land on the test point of the product. After a predetermined number of times the steel ball 20 is dropped, the product's mechanical strength can be determined according to data collected on effect of multiple impacts by the steel ball 20. Using the mechanical strength tester 100 to test the product's mechanical strength can be done with only one person, which is convenient and may reduce costs. Moreover, the steel ball 20 is accommodated in the cylinder 10 during falling, which is very safe. Furthermore, the cylinder 10 can be position accurately on the test point.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mechanical strength tester comprising:
a steel ball; and
a hollow cylinder comprising a supporting configuration apart from a bottom of the cylinder, wherein the diameter of the steel ball is less than the diameter of the cylinder;
wherein the supporting configuration is operable to support the steel ball, or release the steel ball to fall down to the bottom of the cylinder under force of gravity.

2. The mechanical strength tester of claim 1, wherein the supporting configuration comprises a supporting board mounted to the cylinder, the supporting board comprises a first portion movable relative to the cylinder to be located between a first position where the first portion extends into an inner side of the cylinder to support the steel ball, and a second position where the first portion withdraws from the inner side of the cylinder to release the steel ball.

3. The mechanical strength tester of claim 2, wherein the cylinder defines a through hole, through which the first portion of the supporting board extends into or withdraws from the inner side of the cylinder.

4. The mechanical strength tester of claim 2, wherein a supporting portion extends into the inner side of the cylinder from the cylinder, opposite to the first portion of the supporting board, to support the steel ball together with the first portion.

5. The mechanical strength tester of claim 2, wherein the supporting board further comprises a second portion perpendicularly extending from the first portion, the second portion is movably mounted to an outer surface of the cylinder.

6. The mechanical strength tester of claim 5, further comprising a screw bolt, an elastic member, a sleeve, and a nut, wherein the screw bolt extends through the elastic member, the second portion of the supporting board, the sleeve, and the cylinder, to engage with the nut.

7. The mechanical strength tester of claim 6, wherein a second through hole is defined in the cylinder, through which the screw bolt extends.

8. A mechanical strength tester comprising:
a ball; and
a passage structure comprising a passageway and a supporting configuration apart from a bottom of the passageway, wherein the diameter of the ball is less than a width of the passageway; the supporting configuration comprising a supporting board mounted to the passage structure, the supporting board comprising a first portion movable relative to the passage structure to be located between a first position where the first portion extends into the passageway to support the ball, and a second position where the first portion withdraws from the passageway to release the ball to fall down to the bottom of the passageway under force of gravity.

9. The mechanical strength tester of claim 8, wherein the ball is made of a metal material.

10. The mechanical strength tester of claim 8, wherein the passage structure defines a through hole, through which the first portion of the supporting board extends into or withdraws from the inner side of the passage structure.

11. The mechanical strength tester of claim 8, wherein a supporting portion extends into the inner side of the cylinder from the passage structure, opposite to the first portion of the supporting board, to support the ball together with the first portion.

12. The mechanical strength tester of claim 8, wherein the second portion perpendicularly extending from the first portion, the second portion is movably mounted to an outer surface of the passage structure.

13. The mechanical strength tester of claim 12, further comprising a screw bolt, an elastic member, a sleeve, and a nut, wherein the screw bolt extends through the elastic member, the second portion of the supporting board, the sleeve, and the cylinder, to engage with the nut.

14. The mechanical strength tester of claim 13, wherein a second through hole is defined in the passage structure, through which the screw bolt extends.

15. The mechanical strength tester of claim 8, wherein passage structure is a hollow cylinder.
